(19) United States
(12) Patent Application Publication
(10) Pub. No.: US 2014/0345369 A1
(43) Pub. Date: Nov. 27, 2014

(54) System and Method for Measuring Viscosity Using Particle Transit Time in Resonant Microfluidic Channels

(71) Applicant: Affinity Biosensors, LLC, Santa Barbara, CA (US)

(72) Inventor: Ken Babcock, Santa Barbara, CA (US)

(73) Assignee: AFFINITY BIOSENSORS, LLC, Santa Barbara, CA (US)

(21) Appl. No.: 14/259,773

(22) Filed: Apr. 23, 2014

Related U.S. Application Data
(60) Provisional application No. 61/818,174, filed on May 1, 2013.

(51) Int. Cl. G01N 11/06

(52) U.S. Cl. CPC G01N 11/06
USPC 73/54.13

(57) ABSTRACT

A method for measuring a the viscosity of a fluid in a microchannel including steps of introducing a fluid containing particles to the microchannel, causing the fluid to flow through the microchannel by a applying a pressure drop, measuring a transit time of one or more particles through the microchannel, determining the flow rate from the particle transit times and the known volume of the microchannel, and determining the viscosity of the fluid from the flow rate and pressure drop.

### RELATED APPLICATIONS

This application claims priority to U.S. Provisional Application Ser. No. 61/818,174, filed May 1, 2013

### FEDERALLY SPONSORED RESEARCH

N/A

### BACKGROUND OF THE INVENTION

Viscometers based on flow of fluid through a microfluidic channel offer the advantages of speed, precision, and minimal sample consumption. By applying a pressure drop across a microfluidic channel and measuring the flow rate, the viscosity is determined from the linear relationship between flow rate and pressure drop that is exhibited by Newtonian fluids at low Reynolds numbers. However, a direct measurement of flow rate in microchannels is challenging because it is typically below the range of conventional flow meters, making microchannel viscometers difficult to implement. To date few are in use.

### SUMMARY OF THE INVENTION

This specification teaches a method for measuring flow rate and, thereby, viscosity which may in one embodiment include a mechanically resonant microfluidic channel. In some embodiments the particles may be suspended in the fluid to be measured, and the presence and motion of the particles detected by the effect their mass has on the microchannel's resonant frequency. Methods of measuring particle characteristics such as mass and size are described in U.S. Pat. No. 8,087,284, and U.S. application Ser. Nos. 12/305,733 and 12/927,031 incorporated in their entirety by reference. The referenced teachings form the basis for certain commercial particle measurement instruments.

In some embodiments, a pressure drop may be applied across the microchannel, causing the fluid containing the suspended particles to flow through the channel. The detection of the particles may be used to determine their velocity as they are carried by the flow through the microchannel by measuring the interval between the time a particle enters and exits the resonant microchannel. Averaging over a plurality of particles gives a precise measure of flow rate. With the knowledge of the pressure drop and flow rate, the fluid viscosity can be determined.

This final step can be done by using precisely known geometries of the microchannel and the known flow characteristics through channels. For example, Poiseuille-Hagen flow through a circular channel relates flow rate, pressure drop, channel dimensions, and viscosity (ref), and can be extended to channels of other geometries.

In alternative embodiments, a reference fluid of known viscosity (for example, water) may be first flowed through the microchannel using a given pressure drop, and the flow rate determined from the particle transit times as described above. A second, target fluid is then flowed through the microchannel at the same pressure drop, and the flow rate measured for that fluid. The ratio of this flow rate vs. the flow rate of the reference fluid yields the viscosity of the target fluid relative to that of the reference fluid. This approach has the advantage that it does not require knowledge of the absolute values of the pressure drops or of the microchannel dimensions.

In other embodiments, fluids that contain no native particles can be spiked with suitable particles, making the method applicable to any fluid.

The method described herein has been demonstrated to give viscosity values precise and accurate to better than 5% of a range from 0.8 cP to 100 cP in just a few minutes, and could be extended to higher viscosities as needed. In addition, by measuring the corresponding flow rates over a range of pressure drops, shear thickening and shear thinning can be measured.

This description primarily describes embodiments using resonant mass measurement to determine the particle motion and flow rate. However, the principles of the invention can be extended to other embodiments that employ a method that detects flow of particles through a channel, including optical methods and electrozone methods. In the latter, particle motion is detected by change in the electrical impedance of a conductive fluid due to the volume displaced by the particle (the so-called Coulter principle). Measuring particle motion with these methods, using the motion to determine flow rate, and combining this knowledge with pressure drop measurements, constitutes a novel embodiment for measuring viscosity.

### BRIEF DESCRIPTION OF THE DRAWINGS

The specification will be better understood by referring to the Figures.

FIG. 1 shows a microchannel resonator, in which a microfluidic channel is embedded in a mechanically resonant structure such as a cantilever. 1a) cutaway view shows particles suspended in fluid passing through the microchannel inside a mechanically resonant cantilever which oscillates out of the plane of the drawing. 1b) shows the response of the resonant frequency as a particle passes through it.

FIG. 2 shows the measurement of the time Δt for a particle to pass through the microchannel resonator.

FIG. 3 is ) Block diagram of an embodiment of the method for measuring flow rate and viscosity.

FIG. 4 shows Viscosity measurements of water/glycerol mixtures spiked with 1 μm polystyrene beads.

### DETAILED DESCRIPTION OF THE INVENTION

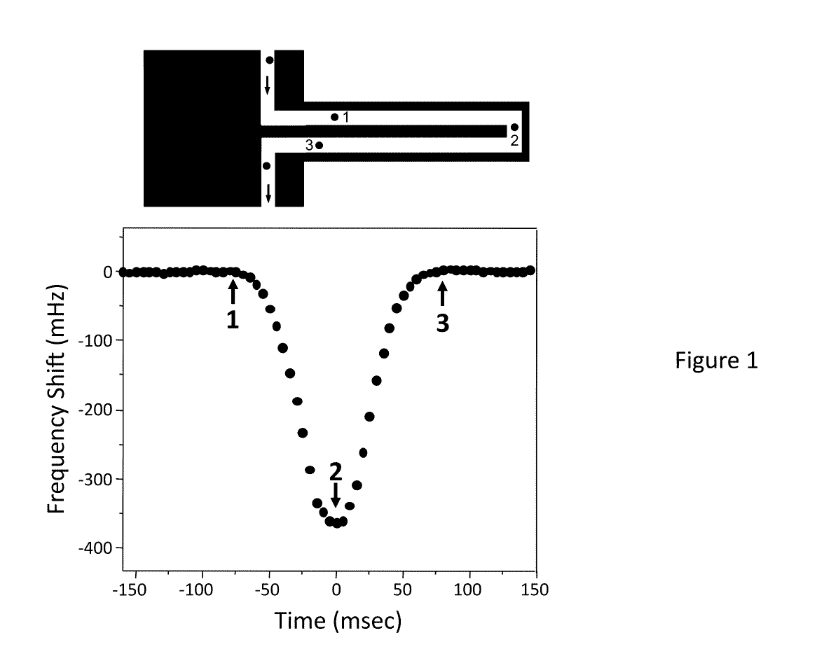

This specification discloses a method for measuring fluid flow rate and viscosity by monitoring a fluid flowing through a sensor comprising a microfluidic channel. FIG. 1 shows an example of such a sensor, in this case a microfluidic channel embedded in a mechanically resonant structure. The structure can be driven to resonate in a vertical direction as the fluid passes through it. Such sensors are described in the incorporated references and can be fabricated with precise micron- and sub-micron scale dimensions using micro-electrical mechanical systems (MEMS) fabrication techniques. Examples include sensors used in commercially available particle measurement instruments which have dimensions between 40 and 300 μm long, with channels having apertures from submicron dimensions up to 30 μm or more. These sensors are referred to as suspended microchannel resonators, (SMR) and the method of measuring particle mass and other properties is known as resonant mass measurement. Typical SMR sensors resonate in a range from 50 kHz to more than 2 MHz, and instrumentation has been developed to measure their resonant frequency with precisions of a few parts per billion at a bandwidth of 1 kHz. While the quantitative characteristics described here are typical of currently available sensors, the measurement principle is not limited to these values, and the method can encompass a wider range of sensor sizes, resonant frequencies, and other characteristics.

FIG. 1b shows a representative time evolution of frequency measurements when a particle suspended in the fluid passes through the resonant portion of the microchannel, with the numbers on the resonant response graph corresponding to the labeled positions of the particle in the microchannel. Because the particle displaces the fluid in the resonator, if its density is greater than that of the fluid, the overall mass of the resonator increases as the particle passes through. This causes the sensor resonant frequency to decrease, then return to its baseline value when the particle exits the sensor. Particle measurement instruments based on such sensors measure the frequency excursion of a series of particles as they pass through the sensor, and from this determine the masses and other physical properties of the particles. For such measurements, and for the measurements described in the embodiment below, the concentration of particles is assumed to be low enough that, for the great majority of the time, at most one particle is present in the sensor at any given time.

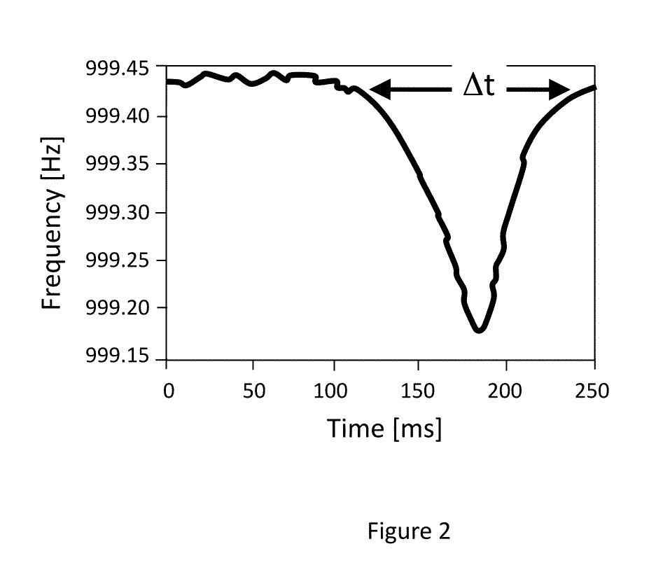

FIG. 2 shows that the transit time Δt, i.e., the time it takes a particle to pass through the sensor, can also be measured. Once the time of transit Δt for a particle is known, its velocity can be determined as V=L/Δt, where L is the path length through the resonating portion of the sensor.

For particles having size less than the channel size, the transit time, and hence the measured particle velocity, can vary from particle to particle, even when the actual fluid flow rate is held constant. This is because the flow velocity is not uniform across the width of the channel. For example, the velocity profile at low Reynolds numbers for flow through a circular channel is parabolic, with a maximum velocity at the channel center, and falling to zero at the channel walls. Therefore, particles that pass through the center of the channel travel faster than those near the walls. By averaging the transit times for several particles, the volumetric flow rate Q (units ml/s) can be determined as Vol/Avg(Δt), where Vol is the volume of the active region of the sensor. For resonant microchannels fabricated using MEMS the volume can be known very precisely from the dimensions of the channel.

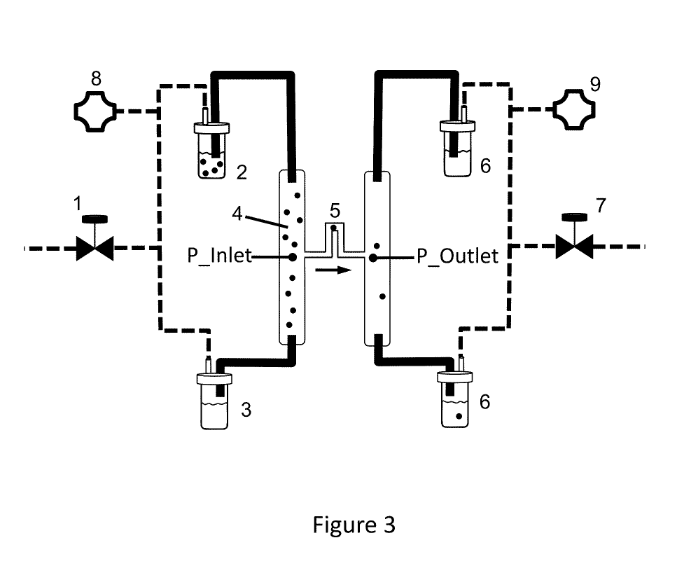

FIG. 3 shows a block diagram of a configuration that allows flow rate through the sensor to be controlled and measured. A head pressure that is regulated with pressure regulator (1) is applied to a vial (2) containing the sample fluid, in which particles are suspended. In a loading phase, the waste vial (3) is vented. The head pressure in the sample vial forces fluid to flow out of the connecting fluidic tubing (blue) and into a large reservoir channel (4). The cross sectional area of the reservoir channel is sufficiently large that the flow rates can be relatively large during this loading phase and the reservoir can be loaded quickly. Once the reservoir channel is filled with sample fluid, the same pressure is applied to waste vial (3). Because vials (1) and (3) both experience the same pressure, flow through the reservoir channel is then stopped.

In coordination with the pressure applied to vial (2), a pressure regulated with pressure regulator (7) is applied to vials (6). The sensor channel (5) connects the inlet reservoir channel (4) to a similar reservoir at its outlet. At this point, a pressure P_Inlet, controlled by regulator (1), is applied at the inlet of sensor (5), and a pressure P_Outlet, controlled by regulator (7), is applied at the sensor outlet. If P_Outlet<P_Inlet, the sample fluid will flow through the resonator. By using the pressure regulators to control the pressure difference ΔP=P_Inlet-P_Outlet, the flow rate through the sensor can be controlled precisely. The pressures ΔP, P_Inlet, and P_Outlet can be measured precisely either by using precision calibrated voltage-controlled regulators, or by monitoring the applied pressures using pressure sensors (8) and (9). Precision regulators and pressure sensors can control or monitor pressures to 0.01 PSI or better, allowing great precision when compared to typically applied pressures and pressure drops from 0.5-100 PSI typical of such a configuration in practice.

The embodiment of FIG. 3 contains several innovative features, and the flow rate and viscosity measurement described herein could not have been accomplished with adequate resolution and accuracy with the systems described in the incorporated references.

The embodiment of FIG. 3 thus supports the following measurements:
the pressures P_Inlet, P_Outlet, and ΔP.
the transit times of particle passing through the sensor, by analyzing the time dependence of the sensor frequency shift caused by the particles
the volumetric flow rate Q by averaging the particle velocities and, if absolute values are desired, the volume Vol of the sensor.

From this information, the viscosity of the sample fluid can be determined using two methods: 1) absolute and 2) relative, as follows:

(1) The absolute method uses the quantitative relationship between pressure, flow rate, channel geometry, and viscosity. For example, for a circular pipe, the flow rate is give by the Hagen-Poiseuille equation:

$$Q = \frac{π {r}^{4} Δ P}{8 μ L} \qquad Equation ( 1 )$$

Here, Q is the volumetric flow rate, r is the radius of the pipe, L is the length of the pipe, ΔP is the pressure drop across the pipe, and μ is the dynamics viscosity of the fluid. By applying a known pressure drop ΔP determining the flow rate using the particle transit time measurements, and known sensor dimensions r and L, the viscosity μ can be determined quantitatively using Equation (1). This approach can be extended to channel geometries other than circular pipes by modifying Equation (1) as appropriate, which can be done for simple channel cross-sections (references to be provided).

(2) The relative method utilizes a reference fluid of known viscosity. First, a reference fluid having viscosity μ_{ref} is flowed through the sensor using a known pressure drop ΔP_{ref}, and its flow rate Q_{ref} is measured using particle transit times. Then the sample fluid is flowed at a pressured drop ΔPₛ and its flow rate Qₛ is also measured using particle transit times. The sample viscosity is then given by

μₛ=μ_{ref}*(Q_{ref}/Qₛ)*(ΔPₛ/ΔP_{ref}) Equation (2)

The relative approach has the advantage that the sensor geometry does not have to be known precisely, nor does the exact equation for flow rate vs. geometry. In fact, the sensor volume Vol is not needed either, since the averages of the article transit times for the reference and sample fluids provide enough information to determine the ratio of the flow rates. That is, the sample viscosity can be determined by these simple ratios:

μₛ=μ_{ref}*((Avg(Δtₛ)/(Avg(Δt_{ref}))*(ΔPₛ/ΔP_{ref}) Equation (3)

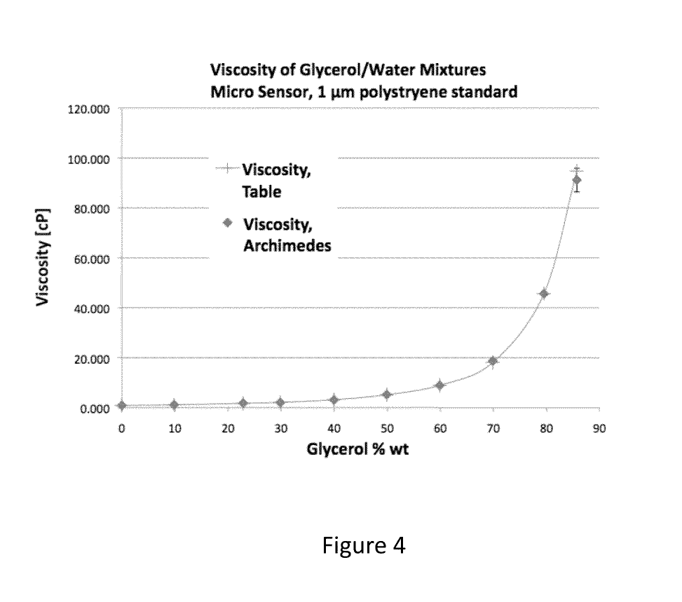

FIG. 4 shows an example of viscosity measurements using the system embodiment in FIG. 3 employing the relative method. A number of mixtures of water and glycerol at different weight ratios and thus viscosities were spiked with 1 μm polystyrene beads. The fluids were flowed through an SMR sensor of square channel cross section with size 8 μm and resonant frequency near 400 kHz. For each fluid, a minimum of 250 particles was flowed through at known pressure and the mean transit times measured. Finally, water spiked with beads was flowed as a reference fluid through at a fixed pressure drop ΔP_{ref} and the transit times measured. The viscosity of the water reference was obtained from a table of standards. Finally, Eq. (3) was used to determine the viscosity of each water/glycerol mixture. FIG. 4 shows the measured results as red diamonds. Blue crosses show the known values for the mixtures via tables (ref). Error bars are shown for all values, representing the standard deviation of three measurements. The agreement between the measurements and tabulated values is excellent.

Modified embodiments of FIG. 3 support similar flow rate and viscosity measurements, and the disclosure should be considered to include these.

In one modification, the resonant mass sensor is replaced by a microfluidic channel coupled with an alternate means of determining the transit time of particles passing through it. For example, a microfluidic channel having optical access could be observed with a high resolution camera capable of detecting the position and motion of particles passing through the channel. Measurement of the particle transit times, combined with pressure measurements similar to those in FIG. 3, could be used to measure flow rate and viscosity. Similarly, an electrozone sensor used with a conducting fluid could be used to determine particle transit times.

In other modifications, the fluidics may not have the same configuration as in FIG. 3. For example, instead of using the large reservoir channels, an embodiment may comprise a simple linear fluid path with no branching. Provided the capability for measuring particle transit time and pressure drop is present, the flow rate and viscosity can be determined by the same principles as in the embodiment FIG. 3.

Other modifications are contemplated. For example, many fluids exhibit a sensitive dependence of viscosity on temperature. Controlling and/or measuring the temperature of the fluid during the measurement of flow rate and viscosity would allow an automatic determination of the viscosity of the reference fluid in the relative method describe above. It would also allow more reproducibility of measurements if, for example, the fluid temperature were held constant between measurements.

Another modification relates to determining the time of entry of a particle into the sensor, and its time of exit. In FIG. 2, the time of entry is determined when sensor frequency value deviates from the baseline by some minimum trigger amount. Thus, the particle's time of entry is detected slightly after it enters the resonant portion of the sensor, with the delay determined by the trigger level. By using a model of the frequency shift vs. position of the particle in the sensor channel, and using the trigger level as an input parameter, the exact times of entry and of exit can be determined. This allows a more precise determination of flow rate since the entry and exit times can be better related to the true sensor volume. In the 2010 doctoral thesis by Phillip Dextras at the Massachusetts Institute of Technology, incorporated by reference, the effect of a particle in the channel on the fundamental resonance of a beam with a fixed end is modeled.

Other embodiments measure the shear thickening or shear thinning of a fluid, that is, the non-Newtonian fluid characteristic wherein the shear is not linearly dependent on the strain. By changing the pressure drop and flow rate through the microchannel, a range of shear values can be accessed. In addition, the pressure drop provides a measure of the strain applied to the fluid. Thus, a profile of shear vs. strain can be obtained for a fluid to determine if there is shear thickening or thinning present and to measure its magnitude. Due to their small cross section, microfluidic channels can introduce significant shear into the flow if desired. For example, for a channel with cross section of 8 μm and length 400 μm, and a flow rate that causes a particle to pass through in 100 ms (a typical value), the shear is approximately 1300 ŝ−1. Exploring shears in a range above and below this value finds application in many shear thinned and thickened fluids.

I claim:

1. A method for measuring a fluid flow rate in a microchannel comprising:
introducing a fluid containing particles to the microchannel,
causing the fluid to flow through the microchannel by a applying a pressure drop,
measuring a transit time of one or more particles through the microchannel, and;
determining the flow rate from the particle transit times and the known volume of the microchannel.

2. The method of claim 1 wherein the transit time is measured using at least one of a resonant mass sensor, optical or electrozone sensor.

3. The method of claim 1 further comprising;
measuring viscosity of the sample, comprising;
measuring the applied pressure drop, and;
using the relationship between microchannel geometry, pressure drop, flow rate, and viscosity to determine the viscosity.

4. A method for measuring fluid flow rate in a microchannel comprising:
introducing a fluid containing particles to a microchannel of known volume, Vol,
applying a pressure drop ΔP across the microchannel to cause the fluid to flow through the channel,
measuring a particle transit time ΔT of one or more particles through the channel, and;
determining a fluid flow rate as Q=Vol/ΔT.

5. The method claim 4 further comprising;
Determining the transit time by averaging over a plurality of particles.

6. The method claim 4, wherein transit time is measured using at least one of a resonant mass sensor, optical or electrozone sensor.

7. A method for measuring fluid viscosity comprising:
introducing a reference fluid having known viscosity μ_{ref} and containing particles to a microchannel, applying a pressure drop ΔP_{ref} across the microchannel to cause the reference fluid to flow through the channel,
measuring particle transit times ΔT_{ref} through the channel,
introducing a sample fluid having unknown viscosity μₛ and containing particles into the channel,
applying a pressure drop ΔPₛ across the microchannel to cause the reference fluid to flow through the channel,
measuring particle transit time ΔTₛ, and;
determining the sample viscosity as μs=μ_{ref}*((Δtₛ)/(Δt_{ref}))*(ΔPₛ/ΔP_{ref}).

8. The method claim 7 further comprising;
Determining the transit times Δtₛ and Δt_{ref} by averaging over a plurality of particles.

9. The method claim 7, wherein the microfluidic channel comprises a resonant mass sensor.

10. The method claim 7, wherein the microfluidic channel is optically accessible and the transit times can be measured by imaging means.

11. The method claim 7, wherein the microfluidic channel comprises an electrozone sensor.

12. A system for measuring viscosity, comprising;
a fluid channel with inlet and outlet ports,
an inlet sample vessel containing particles suspended in fluid,
an inlet pressure regulator,
an inlet pressure sensor,
an outlet pressure regulator,
an outlet pressure sensor, and;
a particle position sensor configured to monitor the movement of suspended particles through the fluid channel, wherein;
the average particle flow rate is controlled by the inlet and outlet pressure regulators through the channel and is determined by the position sensor for a plurality of particles; and using the known pressures at the inlet and outlet of the channel with the known channel geometry, the viscosity of the fluid is determined.

13. The system of claim 12 wherein the particle position sensor includes optical sensors and electrozone sensors.

14. The system of claim 12 wherein the fluid channel is part of a microchannel resonator and the particle position sensor is the mass sensing due to the particles affect on the microchannel resonant frequency as it transits the fluid channel.
